(19) United States
(12) Patent Application Publication
(10) Pub. No.: US 2026/0059273 A1
(43) Pub. Date: Feb. 26, 2026

(54) METHOD AND DEVICE FOR CONVERTING AND TRANSMITTING SENSOR INFORMATION

(71) Applicant: LG ELECTRONICS INC., Seoul (KR)

(72) Inventors: Jaihyun BYUN, Seoul (KR); Hanbyul SEO, Seoul (KR)

(21) Appl. No.: 19/100,862

(22) PCT Filed: Aug. 9, 2023
(86) PCT No.: PCT/KR2023/011758

§ 371 Date: Feb. 3, 2025

(30) Foreign Application Priority Data
Aug. 9, 2022 (KR) 10-2022-0099418
Nov. 4, 2022 (KR) 10-2022-0146541

(51) Int. Cl. H04W 4/38; H04W 4/40

(52) U.S. Cl. CPC H04W 4/38; H04W 4/40

(57) ABSTRACT

Provided are a method by which a first device performs wireless communication, and a device supporting same. The method may comprise the steps of: obtaining first state information of an object on the basis of at least one of information acquired through one or more sensors connected to the first device or information received from one or more devices; converting the first state information into second state information from the perspective of a second device; and transmitting a message including the second state information to the second device.

### CROSS-REFERENCE TO RELATED APPLICATIONS

This application is the National Stage filing under 35 U.S.C. 371 of International Application No. PCT/KR2023/011758 filed on Aug. 9, 2023, which claims the benefit of Korean Patent Application No. 10-2022-0099418 filed on Aug. 9, 2022, and Korean Patent Application No. 10-2022-0146541 filed on Nov. 4, 2022, which are all hereby incorporated by reference herein in their entirety.

### TECHNICAL FIELD

This disclosure relates to a wireless communication system.

### BACKGROUND

A wireless communication system is a multiple access system that supports communication of multiple users by sharing available system resources (e.g. a bandwidth, transmission power, etc.) among them. Examples of multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi-Carrier Frequency Division Multiple Access (MC-FDMA) system.

Sidelink (SL) communication is a communication scheme in which a direct link is established between User Equipments (UEs) and the UEs exchange voice and data directly with each other without intervention of a base station. SL communication is under consideration as a solution to the overhead of a base station caused by rapidly increasing data traffic.

Vehicle-to-everything (V2X) refers to a communication technology through which a vehicle exchanges information with another vehicle, a pedestrian, an object having an infrastructure (or infra) established therein, and so on. The V2X may be divided into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

Meanwhile, as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. And, a next generation radio access technology that is based on the enhanced mobile broadband communication, massive Machine Type Communication (MTC), Ultra-Reliable and Low Latency Communication (URLLC), and so on, may be referred to as a new radio access technology (RAT) or new radio (NR). Vehicle-to-everything (V2X) communication may also be supported in NR.

### SUMMARY

In an embodiment, provided is a method for performing wireless communication by a first device. The method may comprise: obtaining first state information for an object based on at least one of information obtained through one or more sensors connected to the first device or information received from one or more devices: converting the first state information into second state information from a perspective of a second device; and transmitting a message including the second state information to the second device.

In an embodiment, provided is a first device adapted to perform wireless communication. The first device may comprise: at least one transceiver: at least one processor; and at least one memory connected to the at least one processor and storing instructions that, based on being executed by the at least one processor, cause the first device to perform operations comprising: obtaining first state information for an object based on at least one of information obtained through one or more sensors connected to the first device or information received from one or more devices: converting the first state information into second state information from a perspective of a second device; and transmitting a message including the second state information to the second device.

In an embodiment, provided is a processing device adapted to control a first device. The processing device may comprise: at least one processor; and at least one memory connected to the at least one processor and storing instructions that, based on being executed by the at least one processor, cause the first device to perform operations comprising: obtaining first state information for an object based on at least one of information obtained through one or more sensors connected to the first device or information received from one or more devices: converting the first state information into second state information from a perspective of a second device; and transmitting a message including the second state information to the second device.

In an embodiment, provided is a non-transitory computer-readable storage medium storing instructions. The instructions, when executed, may cause a first device to perform operations comprising: obtaining first state information for an object based on at least one of information obtained through one or more sensors connected to the first device or information received from one or more devices; converting the first state information into second state information from a perspective of a second device; and transmitting a message including the second state information to the second device.

### BRIEF DESCRIPTION OF THE DRAWINGS

FIG. 1 shows a communication structure providable in a 6G system, based on an embodiment of the present disclosure.

FIG. 2 shows an electromagnetic spectrum, based on an embodiment of the present disclosure.

FIG. 3 shows a method for representing position information for an object, based on an embodiment of the present disclosure.

FIG. 4 shows position information of a detected object, based on an embodiment of the present disclosure.

FIG. 5 shows a multi-object recognition situation at an intersection, based on an embodiment of the present disclosure.

FIG. 6 shows object information obtained by a sensor and shadow areas, based on an embodiment of the present disclosure.

FIG. 7 shows an example of fusing information measured from different angles by two cameras (PoV #1, 2) of an RSU installed at an intersection, based on an embodiment of the present disclosure.

FIG. 8 shows an example of fusing information measured by each of sensors (PoV #1, 2) of two vehicles positioned at different angles, based on an embodiment of the present disclosure.

FIG. 9 shows an example of a 3D rendering technique, based on an embodiment of the present disclosure.

FIGS. 10 to 14 show examples of providing sensor information obtained from two sensors (PoV #1, 2) connected to an RSU in an intersection environment to a vehicle (PoV #3), based on an embodiment of the present disclosure.

FIG. 15 shows a method for converting and transmitting sensor information, based on an embodiment of the present disclosure.

FIG. 16 shows a method for a first device to perform wireless communication, based on an embodiment of the present disclosure.

FIG. 17 shows a method for a second device to perform wireless communication, based on an embodiment of the present disclosure.

FIG. 18 shows a communication system 1, based on an embodiment of the present disclosure.

FIG. 19 shows wireless devices, based on an embodiment of the present disclosure.

FIG. 20 shows a signal process circuit for a transmission signal, based on an embodiment of the present disclosure.

FIG. 21 shows another example of a wireless device, based on an embodiment of the present disclosure.

FIG. 22 shows a hand-held device, based on an embodiment of the present disclosure.

FIG. 23 shows a vehicle or an autonomous vehicle, based on an embodiment of the present disclosure.

### DETAILED DESCRIPTION

In the present disclosure, “A or B” may mean “only A”, “only B” or “both A and B.” In other words, in the present disclosure, “A or B” may be interpreted as “A and/or B”. For example, in the present disclosure, “A, B, or C” may mean “only A”, “only B”, “only C”, or “any combination of A, B, C”.

A slash (/) or comma used in the present disclosure may mean “and/or”. For example, “A/B” may mean “A and/or B”. Accordingly, “A/B” may mean “only A”, “only B”, or “both A and B”. For example, “A, B, C” may mean “A, B, or C”.

In the present disclosure, “at least one of A and B” may mean “only A”, “only B”, or “both A and B”. In addition, in the present disclosure, the expression “at least one of A or B” or “at least one of A and/or B” may be interpreted as “at least one of A and B”.

In addition, in the present disclosure, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present disclosure may mean “for example”. Specifically, when indicated as “control information (PDCCH)”, it may mean that “PDCCH” is proposed as an example of the “control information”. In other words, the “control information” of the present disclosure is not limited to “PDCCH”, and “PDCCH” may be proposed as an example of the “control information”. In addition, when indicated as “control information (i.e., PDCCH)”, it may also mean that “PDCCH” is proposed as an example of the “control information”.

In the following description, ‘when, if, or in case of’ may be replaced with ‘based on’.

A technical feature described individually in one figure in the present disclosure may be individually implemented, or may be simultaneously implemented.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), and so on. IEEE 802.16m is an evolved version of IEEE 802.16e and provides backward compatibility with a system based on the IEEE 802.16e. The UTRA is part of a universal mobile telecommunication system (UMTS). 3rd generation partnership project (3GPP) long term evolution (LTE) is part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

5G NR is a successive technology of LTE-A corresponding to a new Clean-slate type mobile communication system having the characteristics of high performance, low latency, high availability, and so on. 5G NR may use resources of all spectrum available for usage including low frequency bands of less than 1 GHz, middle frequency bands ranging from 1 GHz to 10 GHz, high frequency (millimeter waves) of 24 GHz or more, and so on.

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as intelligent connectivity, deep connectivity, holographic connectivity and ubiquitous connectivity, and the 6G system may satisfy the requirements shown in Table 1 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

The 6G system may have key factors such as enhanced mobile broadband (eMBB), ultra-reliable low latency communications (URLLC), massive machine type communications (mMTC), AI integrated communication, tactile internet, high throughput, high network capacity, high energy efficiency, low backhaul and access network congestion, and enhanced data security.

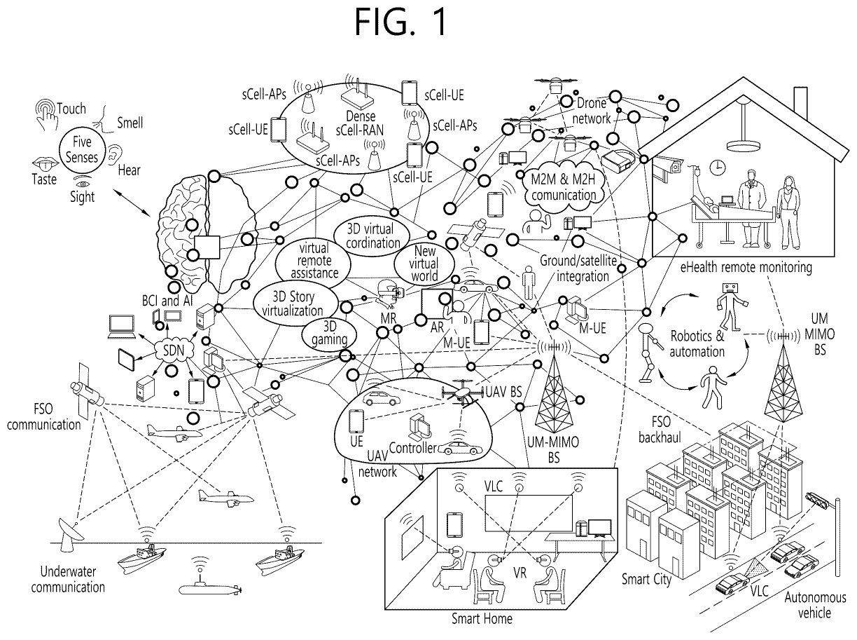

FIG. 1 shows a communication structure providable in a 6G system, based on an embodiment of the present disclosure. The embodiment of FIG. 1 may be combined with various embodiments of the present disclosure.

The 6G system will have 50 times higher simultaneous wireless communication connectivity than a 5G wireless communication system. URLLC, which is the key feature of 5G, will become more important technology by providing end-to-end latency less than 1 ms in 6G communication. The 6G system may have much better volumetric spectrum efficiency unlike frequently used domain spectrum efficiency. The 6G system may provide advanced battery technology for energy harvesting and very long battery life and thus mobile devices may not need to be separately charged in the 6G system. In 6G, new network characteristics may be as follows.
Satellites integrated network: To provide a global mobile group, 6G will be integrated with satellite. Integrating terrestrial waves, satellites and public networks as one wireless communication system may be very important for 6G.
Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer: A 6G wireless network may transfer power in order to charge the batteries of devices such as smartphones and sensors. Therefore, wireless information and energy transfer (WIET) will be integrated.
Ubiquitous super 3-dimension connectivity: Access to networks and core network functions of drones and very low earth orbit satellites will establish super 3D connection in 6G ubiquitous.

In the new network characteristics of 6G, several general requirements may be as follows.
Small cell networks: The idea of a small cell network was introduced in order to improve received signal quality as a result of throughput, energy efficiency and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network composed of heterogeneous networks improves overall QoS and reduces costs.
High-capacity backhaul: Backhaul connection is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability.

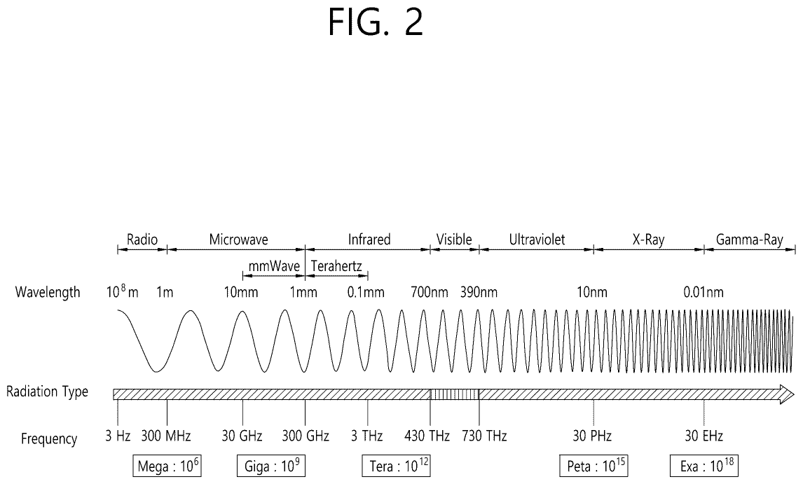

Core implementation technology of 6G system is described below.
Artificial Intelligence (AI): Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay. Operation consuming time such as handover, network selection, and resource scheduling immediately performed by using AI. AI may also play an important role in M2M, machine-to-human, and human-to-machine. In addition, AI may be a prompt communication in brain computer interface (BCI). An AI based communication system may be supported by metamaterial, intelligence structure, intelligence network, intelligence device, intelligence cognitive radio, self-maintaining wireless network, and machine learning.
Terahertz (THz) communication: A data rate may increase by increasing bandwidth. This may be performed by using sub-TH communication with wide bandwidth and applying advanced massive MIMO technology. THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF. FIG. 2 shows an electromagnetic spectrum, based on an embodiment of the present disclosure. The embodiment of FIG. 2 may be combined with various embodiments of the present disclosure. The main characteristics of THz communication include (i) bandwidth widely available to support a very high data rate and (ii) high path loss occurring at a high frequency (a high directional antenna is indispensable). A narrow beam width generated in the high directional antenna reduces interference. The small wavelength of a THz signal allows a larger number of antenna elements to be integrated with a device and BS operating in this band. Therefore, an advanced adaptive arrangement technology capable of overcoming a range limitation may be used.
Massive MIMO technology (large-scale MIMO)
Hologram beamforming (HBF)
Optical wireless technology
Free space optical backhaul network (FSO Backhaul Network)
Non-terrestrial networks (NTN)
Quantum communication
Cell-free communication
Integration of wireless information and power transmission
Integration of wireless communication and sensing
Integrated access and backhaul network
Big data analysis
Reconfigurable intelligent surface
Metaverse
Block-chain
Unmanned aerial vehicle (UAV): An unmanned aerial vehicle (UAV) or drone will be an important factor in 6G wireless communication. In most cases, a high-speed data wireless connection is provided using UAV technology. A base station entity is installed in the UAV to provide cellular connectivity. UAVs have certain features, which are not found in fixed base station infrastructures, such as easy deployment, strong line-of-sight links, and mobility-controlled degrees of freedom. During emergencies such as natural disasters, the deployment of terrestrial telecommunications infrastructure is not economically feasible and sometimes services cannot be provided in volatile environments. The UAV can easily handle this situation. The UAV will be a new paradigm in the field of wireless communications. This technology facilitates the three basic requirements of wireless networks, such as eMBB, URLLC and mMTC. The UAV can also serve a number of purposes, such as network connectivity improvement, fire detection, disaster emergency services, security and surveillance, pollution monitoring, parking monitoring, and accident monitoring. Therefore, UAV technology is recognized as one of the most important technologies for 6G communication.
Autonomous driving (self-driving): For perfect autonomous driving, it is necessary to notify dangerous situation of each other through communication between vehicle and vehicle, to check information like parking information location and signal change time through communication between vehicle and infrastructure such as parking lots and/or traffic lights. Vehicle to everything (V2X) that is a core element for establishing an autonomous driving infrastructure is a technology that vehicle communicates and shares with various elements in road for autonomous driving such as vehicle to vehicle (V2V), vehicle to infrastructure (V2I). To maximize a performance of autonomous driving and to secure high safety, high transmission speed and low latency technology have to be needed. Furthermore, to directly control vehicle in dangerous situation and to actively intervene vehicle driving beyond a level of a warning or a guidance message to driver, as the amount of the information to transmit and receive is larger, autonomous driving is expected to be maximized in 6G being higher transmission speed and lower latency than 5G.

For clarity in the description, 5G NR is mainly described, but the technical idea according to an embodiment of the present disclosure is not limited thereto. Various embodiments of the present disclosure can also be applied to 6G communication systems.

Currently, there is a collective perception service (CPS) as a service that shares information obtained by sensor(s) (e.g., light detection and ranging (LIDAR), radio detection and ranging (RADAR), camera(s), etc.) among intelligent transportation system (ITS) services. In this case, a road user or infrastructure can share information for objects (e.g., road users, obstacles, etc.) detected by one or more sensors of a transmitter with other ITS service users through a collective perception message (CPM) using communication for the purpose of increasing awareness of other road users or obstacles on the road and reducing the risk of collision.

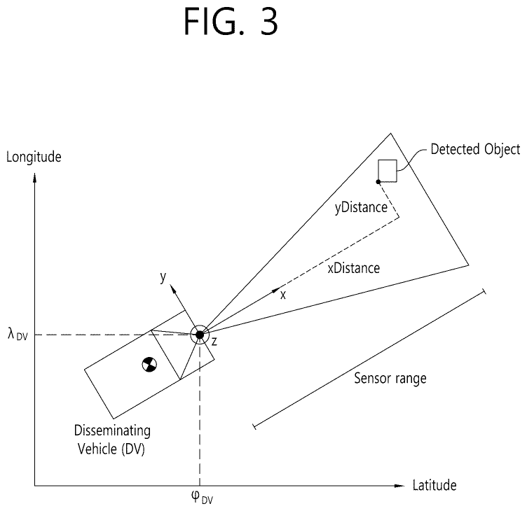

FIG. 3 shows a method for representing position information for an object, based on an embodiment of the present disclosure. The embodiment of FIG. 3 may be combined with various embodiments of the present disclosure.

Referring to FIG. 3, when a transmitter (a disseminating vehicle in FIG. 3) shares information for an object (a detected object in FIG. 3) obtained by sensor(s) through a CPM, position information for the object may be expressed from the transmitter's perspective as a relative coordinate value (xDistance and yDistance in FIG. 3) of the shortest distance from the transmitter's sensor position (ψ_{DV}, λ_{DV}) to the detected object.

A receiver that receives the sensor information through the CPM may calculate the absolute position using the transmitter's sensor position and each detected relative position to know the position of the object.

In addition, if size information of the object is included as optional information in the CPM transmitted by the transmitter to the receiver, the receiver may know not only the position of the transmitter but also three-dimensional information.

Meanwhile, in the conventional sensor information transmission method, when the transmitter detects multiple objects with one sensor, the relative position of the detected objects are expressed from the transmitter's perspective as shown in FIG. 3. This method may have a limitation in using a service when the receiver lacks processing resources to calculate the absolute position.

In addition, when representing the position information for the object as the shortest distance from the transmitter's perspective, the receiver has a limitation in detecting the exact position of a large three-dimensional object.

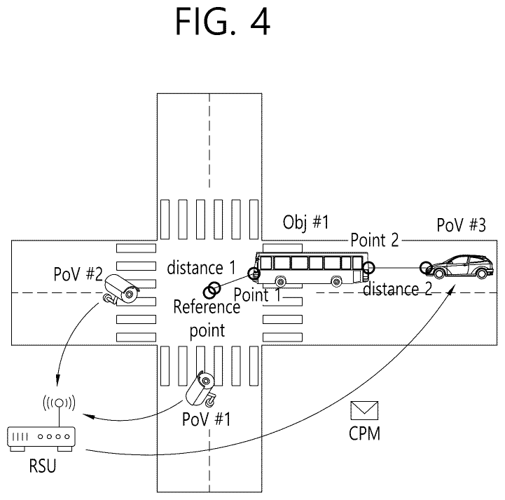

FIG. 4 shows position information of a detected object, based on an embodiment of the present disclosure. The embodiment of FIG. 4 may be combined with various embodiments of the present disclosure.

Referring to FIG. 4, the position information of the object (Obj #1) detected by the RSU (PoV #1, PoV #2) points to point 1. However, from the receiver (PoV #3)'s perspective, point 2 is more valid object position information than point 1, but the RSU transmits the position of point 1 rather than point 2 in the CPM.

If the transmitter detects the object's progress direction value (yaw angle) and size information (length, width, height) with multiple sensors and includes them in the CPM as optional information and transmits them, the receiver shall directly calculate distance 2 and point 2 using the object's position information (point 1) and the size information.

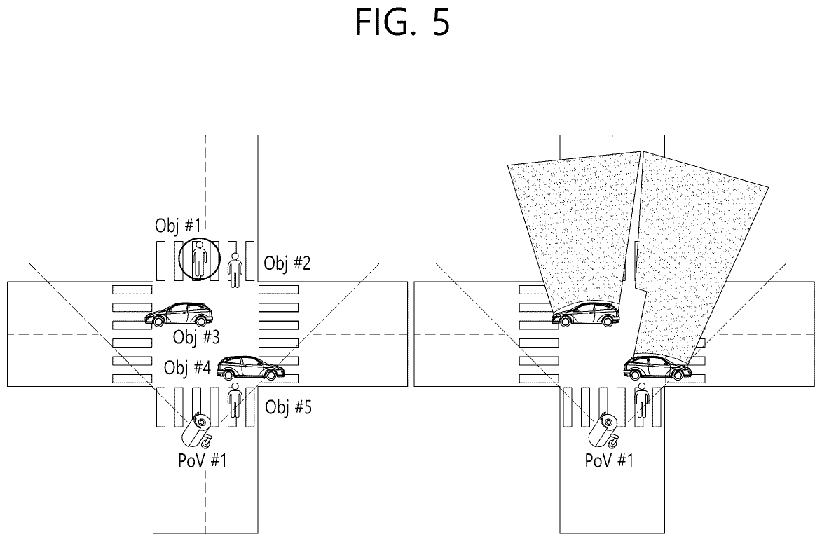

In addition, when using a single sensor, in a crowded road, multiple objects may obscure each other as shown in FIG. 5, and it is difficult to detect all objects with a single sensor. FIG. 5 shows a multi-object recognition situation at an intersection, based on an embodiment of the present disclosure. The embodiment of FIG. 5 may be combined with various embodiments of the present disclosure.

Based on various embodiments of the present disclosure, a method for converting and transmitting sensor information and a device supporting the same are proposed.

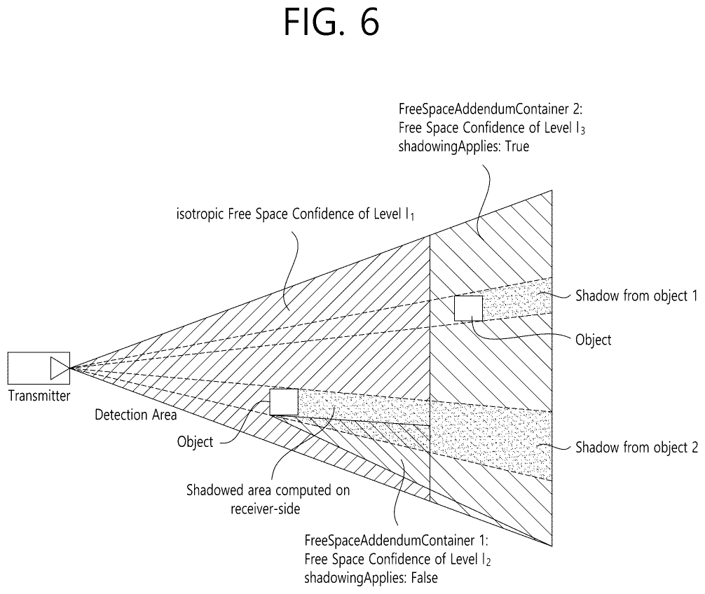

FIG. 6 shows object information obtained by a sensor and shadow areas, based on an embodiment of the present disclosure. The embodiment of FIG. 6 may be combined with various embodiments of the present disclosure.

Referring to FIG. 6, the area detected by the sensor may be as shown in FIG. 6, and the shadow areas such as a shadow area from the object and an area difficult to detect by the sensor may occur.

As a way to improve this, sensor information of multiple transmitters or multiple sensors of the same transmitter (e.g., two or more cameras of an RSU or two or more vehicles facing the same place but with different headings) may be fused (e.g., an ITS server) to minimize such shadow areas.

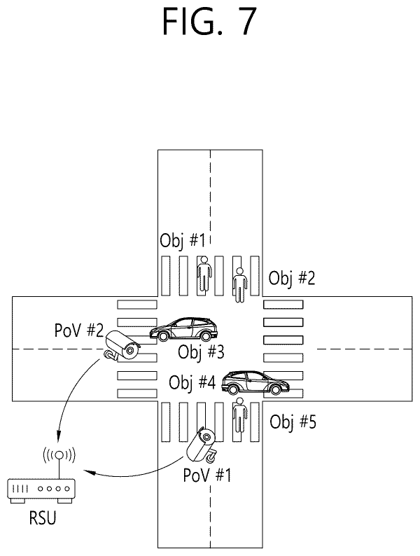

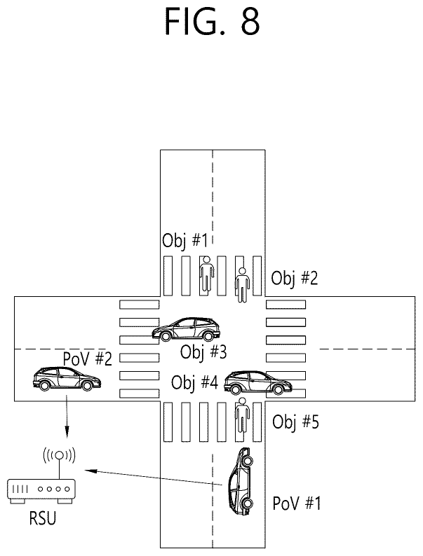

FIG. 7 shows an example of fusing information measured from different angles by two cameras (PoV #1, 2) of an RSU installed at an intersection, based on an embodiment of the present disclosure. FIG. 8 shows an example of fusing information measured by each of sensors (PoV #1, 2) of two vehicles positioned at different angles, based on an embodiment of the present disclosure. The embodiment of FIG. 7 or FIG. 8 may be combined with various embodiments of the present disclosure.

The area where multiple objects are not detected due to interference, overlap, or occlusion in the direction observation of one sensor may be detected by another sensor, thereby increasing the area and number of detectable objects. This process has been described in the embodiment of the present disclosure. In addition, when two or more sensors detect the same object, an operation to check whether the two objects are the same object may be required. As a way to check, if the intersection over union of the area (Z=0) in which the object measured by each sensor is projected onto the ground is greater than or equal to a threshold value (e.g., 80%), the object may be recognized as one object. In this case, the size of the area may not have an effect.

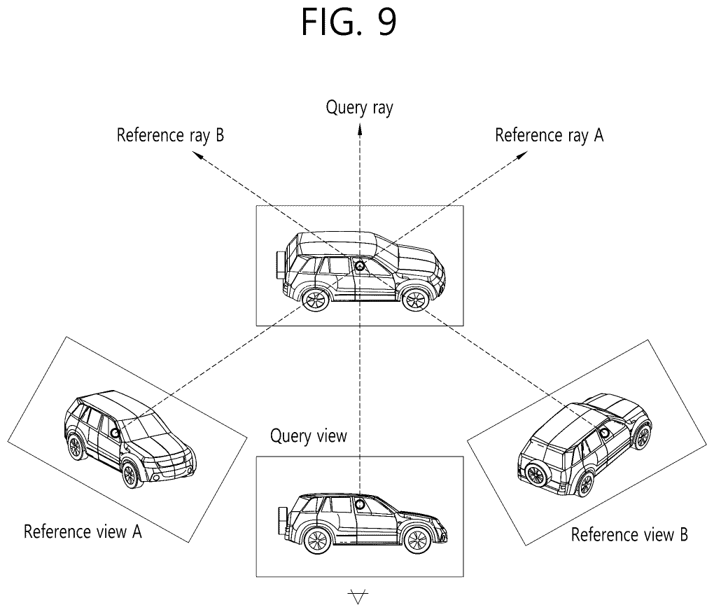

In addition, it is possible to perform an image extraction operation from the receiver's perspective using a 3D rendering technique by utilizing 2D information measured from multiple sensors. Herein, the 3D rendering technique is a technique for obtaining an image from a third perspective using images obtained from two or more perspectives. As shown in FIG. 9, it may be a technique for obtaining an image of a query view by performing various AI algorithm operations using two reference views A and B. FIG. 9 shows an example of a 3D rendering technique, based on an embodiment of the present disclosure. The embodiment of FIG. 9 may be combined with various embodiments of the present disclosure.

Through this technique, 2D images from the perspective of the receiver may be obtained from the 2D information from the perspective of the service provider, and information (e.g., location, direction, etc.) of each object may be converted from the location of the receiver. That is, for the object (Obj #1) shown in FIG. 4, size information of the object can be accurately obtained through the 3D rendering technique using 2D images measured by multiple sensors (PoV #1, 2). Using the obtained size information of the object, the location (point 2) of the object (Obj #1) viewed by the receiver (PoV #3) and the shortest distance (distance 2) between the receiver (PoV #3) and the object (Obj #1) may be calculated.

Based on the operating method of the present disclosure according to the above-described proposal, the shadow area can be minimized by multiple sensors, and the transmitter can calculate information (location, speed/velocity, direction, etc.) of the object from the perspective of the receiver based on information (location, direction) of the receiver through the rendering technique. The transmitter may transmit information for objects converted from the receiver's perspective to the receiver using unicast or groupcast.

For example, as an indication that object information included in a message has been converted from the receiver's perspective, an information flag bit may be added into the message (CPM). For example, the information flag bit may represent that the object information included in the message is information converted from the receiver's perspective. For example, if the transmitter transmits the message including the information flag bit to the receiver, the receiver may know that the object information in the message is information converted from the receiver's perspective based on the information flag bit (e.g., raw data: 0, converted data: 1) after receiving the message.

For example, if the message includes a value converted from the receiver's perspective, optional information such as an object's movement direction value (yaw angle), a size information value (width, length, height), etc. may be added into the message. For example, if the message includes a value converted from the receiver's perspective, optional information, such as an object's movement direction value (yaw angle), a size information value (width, length, height), etc., may be omitted from the message.

For example, if the accuracy of an object's size information value obtained by multiple sensors is determined to be high, optional information may be omitted from the message. For example, if the difference between object's size information values obtained by multiple sensors is less than or equal to a certain value, optional information may be omitted from the message. For example, if object information obtained by multiple sensors is determined to be highly identical or similar, each object may be recognized as the same object, and information for each object may be integrated into one piece of information. For example, if the difference between object's size information values obtained by each sensor in a multi-sensor environment is less than or equal to a certain value, each object may be recognized as the same object, and information for each object may be integrated into one piece of information. In this case, for example, the transmitter may include a value that fuses information obtained by each sensor in the message or include a representative sensor value, and the remaining sensor values may be omitted from the message.

For example, if an object's size information value obtained by multiple sensors has changed from a previous value, optional information may be added into the message. For example, if the object's size information value obtained by multiple sensors has changed from the previous value due to a measurement error, actual size change, etc., optional information may be added into the message.

For example, if an object's movement direction value (yaw angle) cannot be measured or is inaccurate (e.g., in a stationary state), object's size information may be omitted from the message. For example, if an object's movement direction value (yaw angle) cannot be measured or is inaccurate (e.g., in a stationary state) since the object's movement direction value (yaw angle) is a reference point that represents object's size information, object's size information may be omitted from the message.

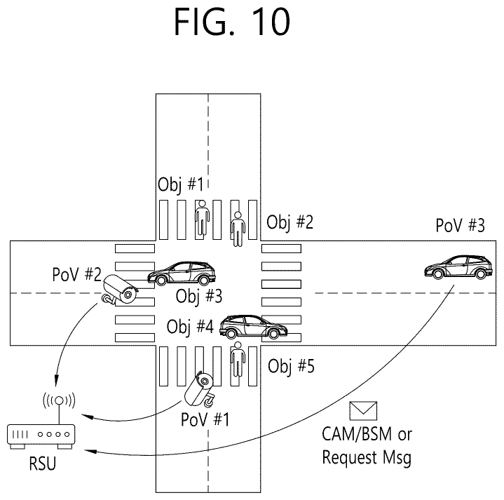

FIGS. 10 to 14 show examples of providing sensor information obtained from two sensors (PoV #1, 2) connected to an RSU in an intersection environment to a vehicle (PoV #3), based on an embodiment of the present disclosure. The embodiments of FIGS. 10 to 14 may be combined with various embodiments of the present disclosure.

Referring to FIGS. 10 to 14, the RSU may receive information (position, direction, etc.) of the receiver (PoV #3) through an awareness message (e.g., CAM) or through a separate sensor information request message of the receiver.

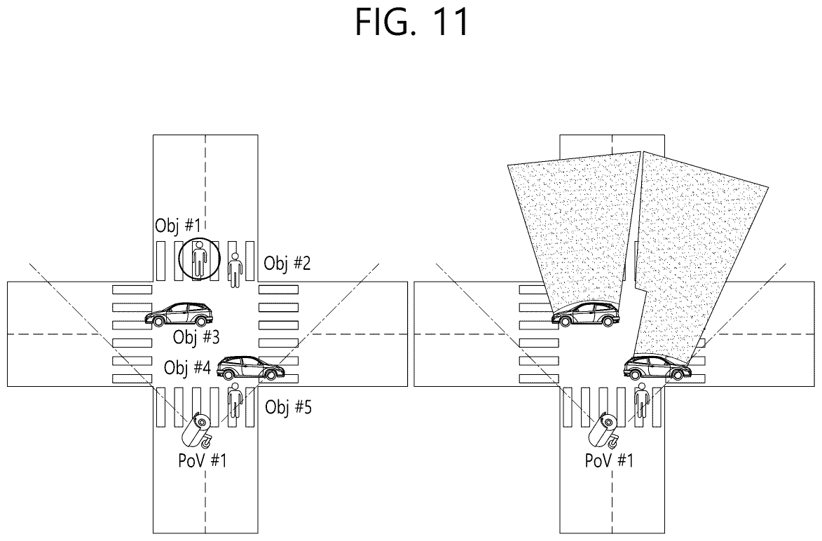

Referring to FIG. 11, there may be five objects (Obj #1 to 5) at the intersection, and information obtained from the sensor (PoV #1) may include objects (Obj #2, 3, 4, 5) as shown in FIG. 11, and there may be the object (Obj #1) that is not detected because it is hidden in the shadow area of the object (Obj #3).

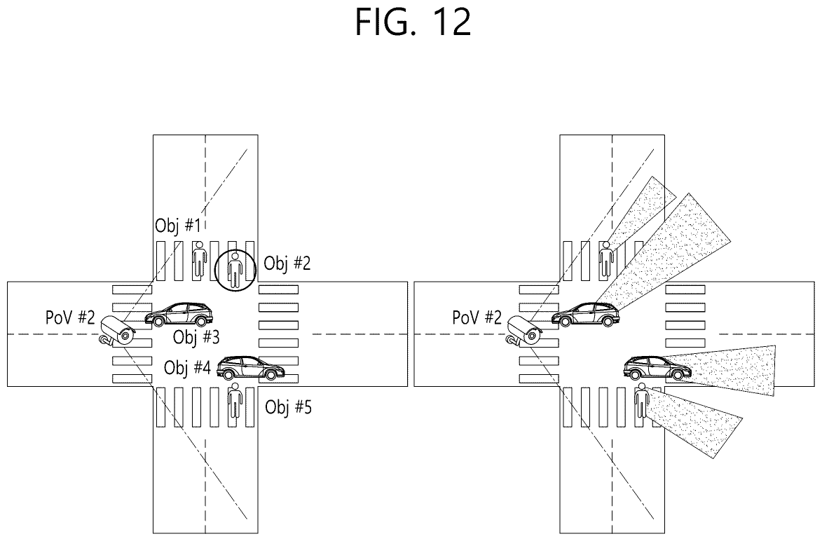

Similarly, referring to FIG. 12, information obtained from another sensor (PoV #2) also has the shadow area of the object (Obj #3), and the object (Obj #2) cannot be detected because the object (Obj #2) is hidden.

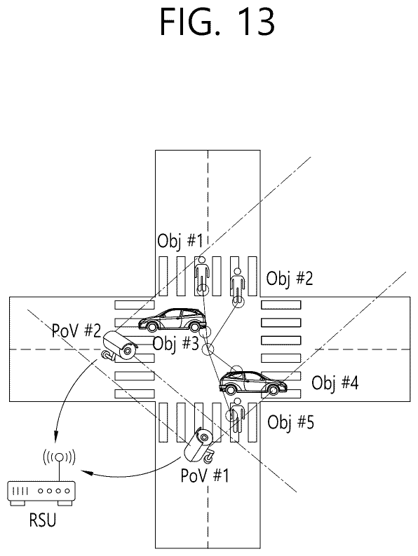

In order to improve these problems, the shadow area can be minimized by fusing the information obtained from different two sensors. Referring to FIG. 13, all objects including the hidden objects (Obj #1, 2) can be detected. With this information fusion method, more objects can be detected and location information can be derived in various cases.

For example, for the objects (Obj #3, 4, 5) detected by both sensors (PoV #2, 3), the size of the area projected on the ground of each object may be compared. In this case, if the overlapping area is 80% or more, the objects may be recognized as the same object.

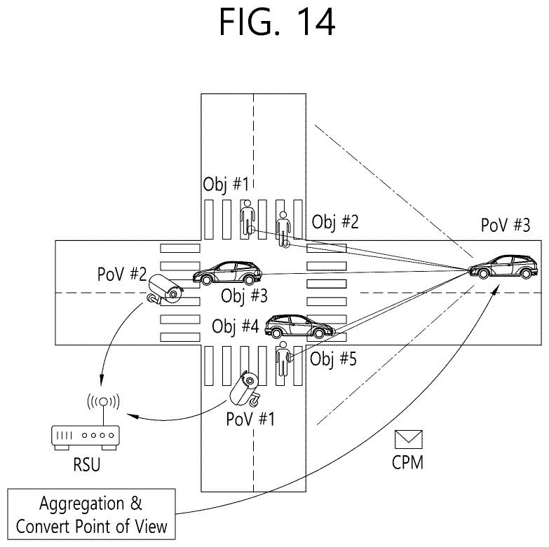

After detecting the objects as much as possible by minimizing the shadow area through the above process, exact size information of each object may be derived through the 3D rendering technique. Based on the reference position of the transmitter and the relative position and/or size information of each object, the transmitter may convert information for objects into information for objects from the receiver's perspective (PoV #3) as shown in FIG. 14. Thereafter, the transmitter may include the transformed information in a CPM and transmit it to the receiver (PoV #3) using unicast or groupcast.

When transmitting position values of objects converted from the receiver's perspective in the CPM, if size information values of the objects are accurate, size information may be omitted to reduce the size of the message. Since the data size of the size information is proportional to the number of objects, if the number of objects included in one message (CPM) is large, the message size reduction effect can be large.

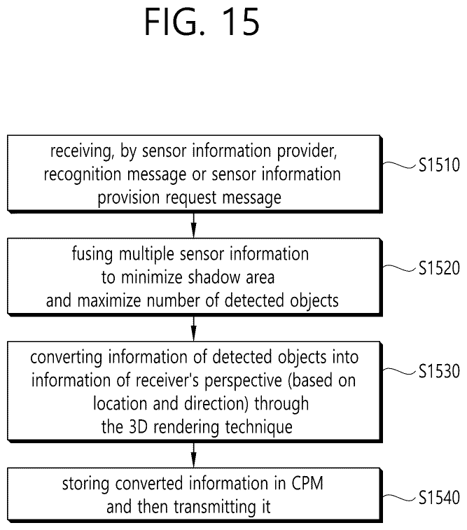

FIG. 15 shows a method for converting and transmitting sensor information, based on an embodiment of the present disclosure. The embodiment of FIG. 15 may be combined with various embodiments of the present disclosure.

Referring to FIG. 15, in step S1510, the sensor information provider may receive a recognition message or a sensor information provision request message from the receiver. In step S1520, the sensor information provider may fuse multiple sensor information to minimize the shadow area and maximize the number of detected objects. In step S1530, the sensor information provider may convert information of the detected objects into information of the receiver's perspective (based on location and direction) through the 3D rendering technique. In step S1540, the sensor information provider may store the converted information in the CPM and then transmit it. Some steps in the embodiment of FIG. 15 may be omitted.

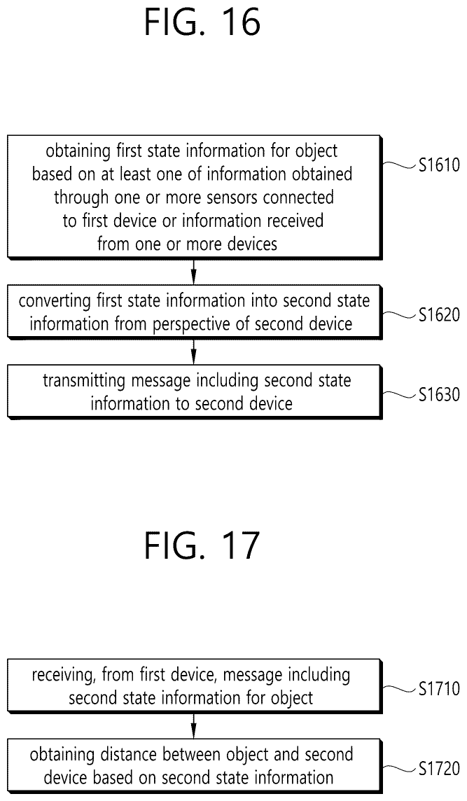

FIG. 16 shows a method for a first device to perform wireless communication, based on an embodiment of the present disclosure. The embodiment of FIG. 16 may be combined with various embodiments of the present disclosure.

Referring to FIG. 16, in step S1610, the first device may obtain first state information for an object based on at least one of information obtained through one or more sensors connected to the first device or information received from one or more devices. In step S1620, the first device may convert the first state information into second state information from a perspective of a second device. In step S1630, the first device may transmit a message including the second state information to the second device.

For example, the message may be a collective perception message (CPM).

For example, the second state information may include at least one of position information for the object, direction information for the object, speed information for the object, or size information for the object, converted from the perspective of the second device.

For example, the message may include information representing that the second state information is information converted from the perspective of the second device. For example, the information representing that the second state information may be information converted from the perspective of the second device is a 1-bit flag.

For example, based on that the information representing that the second state information is information converted from the perspective of the second device is included in the message, size information for the object may be excluded from the second state information.

For example, based on that the information representing that the second state information is information converted from the perspective of the second device is included in the message, and based on that accuracy of size information for the object is greater than or equal to a threshold, the size information for the object may be excluded from the second state information.

For example, based on that the information representing that the second state information is information converted from the perspective of the second device is included in the message, and based on that accuracy of direction information for the object is less than or equal to a threshold, size information for the object may be excluded from the second state information.

For example, the message including the second state information may be transmitted to the second device based on groupcast or unicast.

Additionally, for example, the first device may obtain third state information for the object from the first state information based on 3D rendering. For example, the second state information may be obtained based on at least one of reference position information of the first device, position information of the second device, or the third state information.

Additionally, for example, the first device may receive, from the second device, an awareness message or a sensor information request message including at least one of position information or direction information of the second device.

For example, the first state information may be information obtained by minimizing a shadow area and maximizing a number of detected objects based on at least one of information obtained through the one or more sensors connected to the first device or the information received from one or more devices.

For example, the first device may be a road side unit (RSU) or an intelligent transportation system (ITS) server.

The proposed method can be applied to device(s) based on various embodiments of the present disclosure. First, the processor 102 of the first device 100 may obtain first state information for an object based on at least one of information obtained through one or more sensors connected to the first device or information received from one or more devices. In addition, the processor 102 of the first device 100 may convert the first state information into second state information from a perspective of a second device. In addition, the processor 102 of the first device 100 may control the transceiver 106 to transmit a message including the second state information to the second device.

Based on an embodiment of the present disclosure, a first device adapted to perform wireless communication may be provided. For example, the first device may comprise: at least one transceiver: at least one processor; and at least one memory connected to the at least one processor and storing instructions. For example, the instructions, based on being executed by the at least one processor, may cause the first device to perform operations comprising: obtaining first state information for an object based on at least one of information obtained through one or more sensors connected to the first device or information received from one or more devices; converting the first state information into second state information from a perspective of a second device; and transmitting a message including the second state information to the second device.

Based on an embodiment of the present disclosure, a processing device adapted to control a first device may be provided. For example, the processing device may comprise: at least one processor; and at least one memory connected to the at least one processor and storing instructions. For example, the instructions, based on being executed by the at least one processor, may cause the first device to perform operations comprising: obtaining first state information for an object based on at least one of information obtained through one or more sensors connected to the first device or information received from one or more devices; converting the first state information into second state information from a perspective of a second device; and transmitting a message including the second state information to the second device.

Based on an embodiment of the present disclosure, a non-transitory computer-readable storage medium storing instructions may be provided. For example, the instructions, when executed, may cause a first device to perform operations comprising: obtaining first state information for an object based on at least one of information obtained through one or more sensors connected to the first device or information received from one or more devices; converting the first state information into second state information from a perspective of a second device; and transmitting a message including the second state information to the second device.

FIG. 17 shows a method for a second device to perform wireless communication, based on an embodiment of the present disclosure. The embodiment of FIG. 17 may be combined with various embodiments of the present disclosure.

Referring to FIG. 17, in step S1710, the second device may receive, from a first device, a message including second state information for an object. In step S1720, the second device may obtain a distance between the object and the second device based on the second state information. For example, first state information for the object may be obtained based on at least one of information obtained through one or more sensors connected to the first device or information received from one or more devices. For example, the first state information may be converted into the second state information from a perspective of the second device by the first device.

The proposed method can be applied to device(s) based on various embodiments of the present disclosure.

First, the processor 202 of the second device 200 may receive, from a first device, a message including second state information for an object. In addition, the processor 202 of the second device 200 may obtain a distance between the object and the second device based on the second state information. For example, first state information for the object may be obtained based on at least one of information obtained through one or more sensors connected to the first device or information received from one or more devices. For example, the first state information may be converted into the second state information from a perspective of the second device by the first device.

Based on an embodiment of the present disclosure, a second device adapted to perform wireless communication may be provided. For example, the second device may comprise: at least one transceiver; at least one processor; and at least one memory connected to the at least one processor and storing instructions. For example, the instructions, based on being executed by the at least one processor, may cause the second device to perform operations comprising: receiving, from a first device, a message including second state information for an object; and obtaining a distance between the object and the second device based on the second state information. For example, first state information for the object may be obtained based on at least one of information obtained through one or more sensors connected to the first device or information received from one or more devices. For example, the first state information may be converted into the second state information from a perspective of the second device by the first device.

Based on an embodiment of the present disclosure, a processing device adapted to control a second device may be provided. For example, the processing device may comprise: at least one processor; and at least one memory connected to the at least one processor and storing instructions. For example, the instructions, based on being executed by the at least one processor, may cause the second device to perform operations comprising: receiving, from a first device, a message including second state information for an object; and obtaining a distance between the object and the second device based on the second state information. For example, first state information for the object may be obtained based on at least one of information obtained through one or more sensors connected to the first device or information received from one or more devices. For example, the first state information may be converted into the second state information from a perspective of the second device by the first device.

Based on an embodiment of the present disclosure, a non-transitory computer-readable storage medium storing instructions may be provided. For example, the instructions, when executed, may cause a second device to perform operations comprising: receiving, from a first device, a message including second state information for an object; and obtaining a distance between the object and the second device based on the second state information. For example, first state information for the object may be obtained based on at least one of information obtained through one or more sensors connected to the first device or information received from one or more devices. For example, the first state information may be converted into the second state information from a perspective of the second device by the first device.

Based on various embodiments of the present disclosure, the information provider (e.g., RSU, server) equipped with multiple sensors at various angles can obtain one or more multi-angle sensor information measured by multiple sensors. In addition, optionally, the information provider can fuse the information. In addition, the information provider can convert the sensor information into a viewpoint based on location information and direction information of a specific receiver or group. In addition, the information provider can transmit the converted information to the receiver or group based on unicast or groupcast.

Based on various embodiments of the present disclosure, first, the transmitter (e.g., RSU, server) with sufficient processing resources can convert the information into the viewpoint of the receive or the group of receivers, and through this, the receiver with small processing resources can smoothly use the service. In addition, the receiver can know the shortest distance (distance 2 in FIG. 4) of the object from the receiver's viewpoint with small processing resources. That is, if the transmitter recognizes the object and specifies its location, the point (point 1 in FIG. 4) is the closest point to the transmitter, but the transmitter can convert the point into the closest point (point 2 in FIG. 4) when the receiver looks at it and transmit it according to the method proposed in the present disclosure. Therefore, the receiver can effectively recognize the object.

In addition, the transmitter can omit transmitting direction and size information of the object required for the receiver to derive the closest point (point 2 in FIG. 4). By omitting the direction and size information of the object in the message, the size of the transmitted message can be reduced. The larger the number of objects included in the message, the greater the effect of reducing the size of the message. In addition, multiple sensors installed or positioned at various angles can detect even hidden objects in a crowded situation, and the size information of the object can also have higher accuracy.

The various embodiments of the present disclosure may be combined with each other.

Hereinafter, device(s) to which various embodiments of the present disclosure can be applied will be described.

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

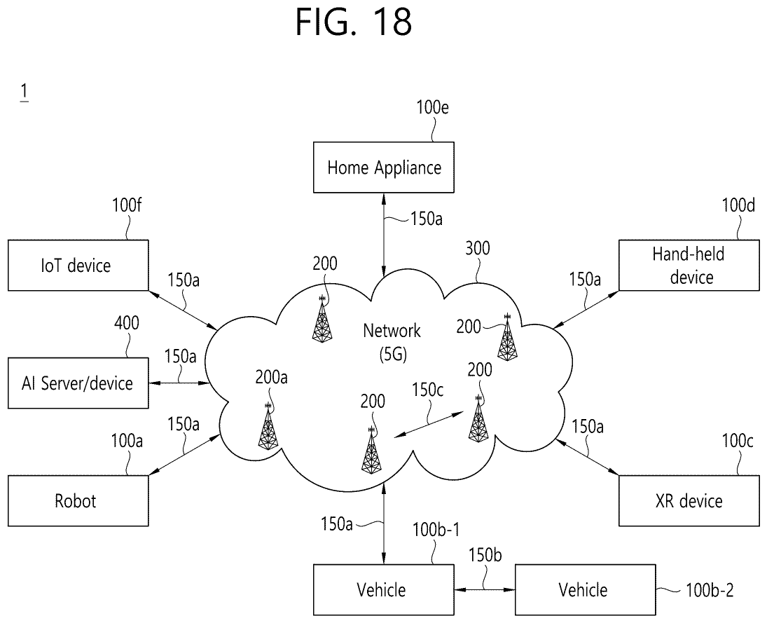

FIG. 18 shows a communication system 1, based on an embodiment of the present disclosure. The embodiment of FIG. 18 may be combined with various embodiments of the present disclosure.

Referring to FIG. 18, a communication system 1 to which various embodiments of the present disclosure are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

Here, wireless communication technology implemented in wireless devices 100a to 100f of the present disclosure may include Narrowband Internet of Things for low-power communication in addition to LTE, NR, and 6G. In this case, for example, NB-IoT technology may be an example of Low Power Wide Area Network (LPWAN) technology and may be implemented as standards such as LTE Cat NB1, and/or LTE Cat NB2, and is not limited to the name described above. Additionally or alternatively, the wireless communication technology implemented in the wireless devices 100a to 100f of the present disclosure may perform communication based on LTE-M technology. In this case, as an example, the LTE-M technology may be an example of the LPWAN and may be called by various names including enhanced Machine Type Communication (eMTC), and the like. For example, the LTE-M technology may be implemented as at least any one of various standards such as 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M, and is not limited to the name described above. Additionally or alternatively, the wireless communication technology implemented in the wireless devices 100a to 100f of the present disclosure may include at least one of Bluetooth, Low Power Wide Area Network (LPWAN), and ZigBee considering the low-power communication, and is not limited to the name described above. As an example, the ZigBee technology may generate personal area networks (PAN) related to small/low-power digital communication based on various standards including IEEE 802.15.4, and the like, and may be called by various names.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

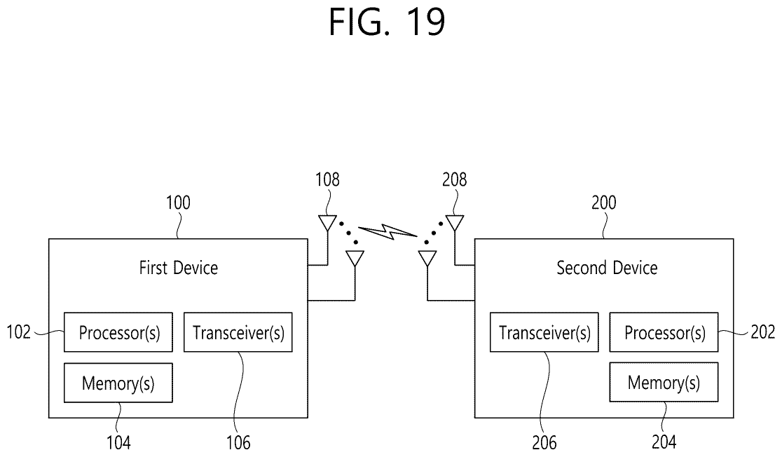

FIG. 19 shows wireless devices, based on an embodiment of the present disclosure. The embodiment of FIG. 19 may be combined with various embodiments of the present disclosure.

Referring to FIG. 19, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 18.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

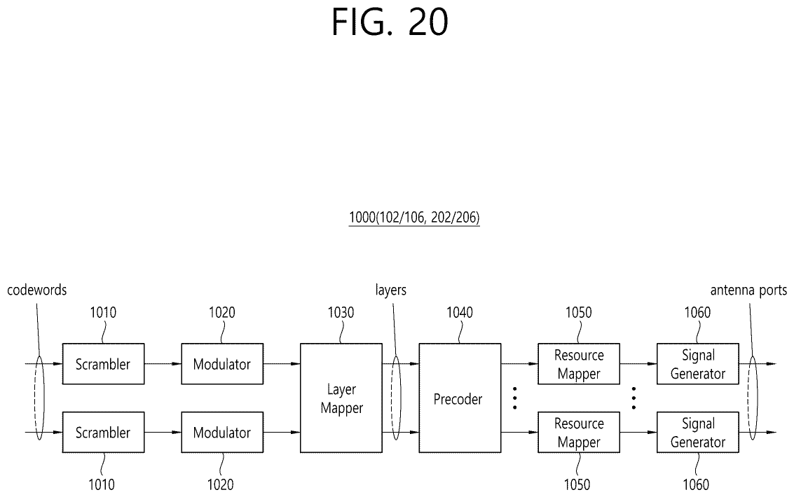

FIG. 20 shows a signal process circuit for a transmission signal, based on an embodiment of the present disclosure. The embodiment of FIG. 20 may be combined with various embodiments of the present disclosure.

Referring to FIG. 20, a signal processing circuit 1000 may include scramblers 1010, modulators 1020, a layer mapper 1030, a precoder 1040, resource mappers 1050, and signal generators 1060. An operation/function of FIG. 20 may be performed, without being limited to, the processors 102 and 202 and/or the transceivers 106 and 206 of FIG. 19. Hardware elements of FIG. 20 may be implemented by the processors 102 and 202 and/or the transceivers 106 and 206 of FIG. 19. For example, blocks 1010 to 1060 may be implemented by the processors 102 and 202 of FIG. 19. Alternatively, the blocks 1010 to 1050 may be implemented by the processors 102 and 202 of FIG. 19 and the block 1060 may be implemented by the transceivers 106 and 206 of FIG. 19.

Codewords may be converted into radio signals via the signal processing circuit 1000 of FIG. 20. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 1010 to 1060 of FIG. 20. For example, the wireless devices (e.g., 100 and 200 of FIG. 19) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

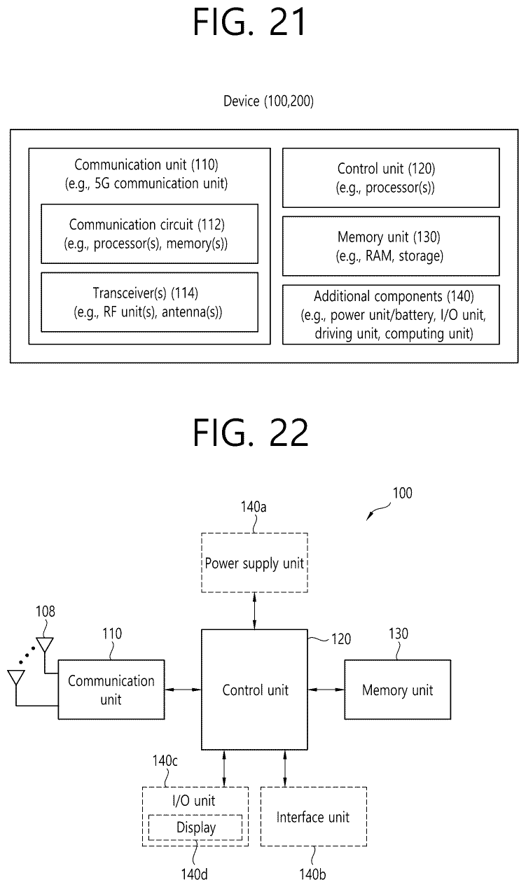

FIG. 21 shows another example of a wireless device, based on an embodiment of the present disclosure. The wireless device may be implemented in various forms according to a use-case/service (refer to FIG. 18). The embodiment of FIG. 21 may be combined with various embodiments of the present disclosure.

Referring to FIG. 21, wireless devices 100 and 200 may correspond to the wireless devices 100 and 200 of FIG. 19 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 19. For example, the transceiver(s) 114 may include the one or more transceivers 106 and 206 and/or the one or more antennas 108 and 208 of FIG. 19. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 18), the vehicles (100b-1 and 100b-2 of FIG. 18), the XR device (100c of FIG. 18), the hand-held device (100d of FIG. 18), the home appliance (100e of FIG. 18), the IoT device (100f of FIG. 18), a digital broadcast terminal, a hologram device, a public safety device, an MTC device, a medicine device, a fintech device (or a finance device), a security device, a climate/environment device, the AI server/device (400 of FIG. 18), the BSs (200 of FIG. 18), a network node, etc. The wireless device may be used in a mobile or fixed place according to a use-example/service.

In FIG. 21, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 21 will be described in detail with reference to the drawings.

FIG. 22 shows a hand-held device, based on an embodiment of the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT). The embodiment of FIG. 22 may be combined with various embodiments of the present disclosure.

Referring to FIG. 22, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 21, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

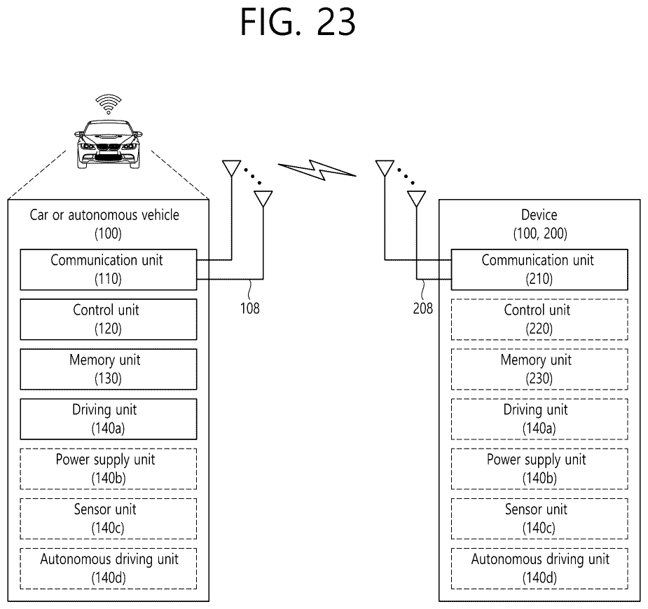

FIG. 23 shows a vehicle or an autonomous vehicle, based on an embodiment of the present disclosure. The vehicle or autonomous vehicle may be implemented by a mobile robot, a car, a train, a manned/unmanned Aerial Vehicle (AV), a ship, etc. The embodiment of FIG. 23 may be combined with various embodiments of the present disclosure.

Referring to FIG. 23, a vehicle or autonomous vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 21, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous vehicle 100. The control unit 120 may include an Electronic Control Unit (ECU). The driving unit 140a may cause the vehicle or the autonomous vehicle 100 to drive on a road. The driving unit 140a may include an engine, a motor, a powertrain, a wheel, a brake, a steering device, etc. The power supply unit 140b may supply power to the vehicle or the autonomous vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous vehicles and provide the predicted traffic information data to the vehicles or the autonomous vehicles.

Claims in the present description can be combined in a various way. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method.

1. A method, comprising:
obtaining first state information for an object based on at least one of information obtained through one or more sensors connected to a first device or information received from one or more devices;
converting the first state information into second state information from a perspective of a second device; and
transmitting a message including the second state information to the second device.

2. The method of claim 1, wherein the message is a collective perception message (CPM).

3. The method of claim 1, wherein the second state information includes at least one of position information for the object, direction information for the object, speed information for the object, or size information for the object, converted from the perspective of the second device.

4. The method of claim 1, wherein the message includes information representing that the second state information is information converted from the perspective of the second device.

5. The method of claim 4, wherein the information representing that the second state information is information converted from the perspective of the second device is a 1-bit flag.

6. The method of claim 1, wherein, based on that the information representing that the second state information is information converted from the perspective of the second device is included in the message, size information for the object is excluded from the second state information.

7. The method of claim 1, wherein, based on that the information representing that the second state information is information converted from the perspective of the second device is included in the message, and based on that accuracy of size information for the object is greater than or equal to a threshold, the size information for the object is excluded from the second state information.

8. The method of claim 1, wherein, based on that the information representing that the second state information is information converted from the perspective of the second device is included in the message, and based on that accuracy of direction information for the object is less than or equal to a threshold, size information for the object is excluded from the second state information.

9. The method of claim 1, wherein the message including the second state information is transmitted to the second device based on groupcast or unicast.

10. The method of claim 1, further comprising:
obtaining third state information for the object from the first state information based on 3D rendering,
wherein the second state information is obtained based on at least one of reference position information of the first device, position information of the second device, or the third state information.

11. The method of claim 1, further comprising:
receiving, from the second device, an awareness message or a sensor information request message including at least one of position information or direction information of the second device.

12. The method of claim 1, wherein the first state information is information obtained by minimizing a shadow area and maximizing a number of detected objects based on at least one of information obtained through the one or more sensors connected to the first device or the information received from one or more devices.

13. The method of claim 1, wherein the first device is a road side unit (RSU) or an intelligent transportation system (ITS) server.

14. A first device, comprising:
at least one transceiver;
at least one processor; and
at least one memory connected to the at least one processor and storing instructions that, based on being executed by the at least one processor, cause the first device to perform operations comprising:
obtaining first state information for an object based on at least one of information obtained through one or more sensors connected to the first device or information received from one or more devices;
converting the first state information into second state information from a perspective of a second device; and
transmitting a message including the second state information to the second device.

15. A processing device adapted to control a first device, the processing device comprising:
at least one processor; and
at least one memory connected to the at least one processor and storing instructions that, based on being executed by the at least one processor, cause the first device to perform operations comprising:
obtaining first state information for an object based on at least one of information obtained through one or more sensors connected to the first device or information received from one or more devices;
converting the first state information into second state information from a perspective of a second device; and
transmitting a message including the second state information to the second device.

16.-20. (canceled)

21. The first device of claim 14, wherein the message is a collective perception message (CPM).

22. The first device of claim 14, wherein the second state information includes at least one of position information for the object, direction information for the object, speed information for the object, or size information for the object, converted from the perspective of the second device.

23. The first device of claim 14, wherein the message includes information representing that the second state information is information converted from the perspective of the second device.

24. The first device of claim 23, wherein the information representing that the second state information is information converted from the perspective of the second device is a 1-bit flag.

25. The first device of claim 14, wherein, based on that the information representing that the second state information is information converted from the perspective of the second device is included in the message, size information for the object is excluded from the second state information.
